(19) United States
(12) Patent Application Publication
(10) Pub. No.: US 2024/0400395 A1
(43) Pub. Date: Dec. 5, 2024

(54) METHOD OF MANUFACTURING GRAPHENE

(71) Applicant: ROHM CO., LTD., Kyoto (JP)

(72) Inventor: Keiju SATO, Kyoto-shi (JP)

(73) Assignee: ROHM CO., LTD., Kyoto (JP)

(21) Appl. No.: 18/806,177

(22) Filed: Aug. 15, 2024

Related U.S. Application Data
(63) Continuation of application No. PCT/JP2023/009350, filed on Mar. 10, 2023.

(30) Foreign Application Priority Data
Mar. 25, 2022 (JP) 2022-050029

(51) Int. Cl. C01B 32/186

(52) U.S. Cl. CPC C01B 32/186

(57) ABSTRACT

The method of manufacturing graphene comprises placing a semiconductor substrate on a carbon susceptor, placing a supply member above the carbon susceptor or a semiconductor substrate, heating the supply member and the carbon susceptor by at least one of a first heating source and a second heating source, heating the semiconductor substrate by heating the carbon susceptor, and forming one or more graphene layers on the semiconductor substrate.

### CROSS REFERENCE TO RELATED APPLICATIONS AND INCORPORATION BY REFERENCE

This is a continuation application (CA) of PCT Application No. PCT/JP2023/9350, filed on Mar. 10, 2023, which claims priority to Japan Patent Application No. P2022-050029 filed on Mar. 25, 2022 and is based upon and claims the benefit of priority from prior Japanese Patent Application No. P2022-050029 filed on Mar. 25, 2022 and PCT Application No. PCT/JP2023/9350, filed on Mar. 10, 2023; the entire contents of each of which are incorporated herein by reference.

### TECHNICAL FIELD

The embodiments relate to a method of manufacturing graphene.

### BACKGROUND ART

In the method of manufacturing graphene, it is known that a silicon carbide substrate is heated in a high vacuum of 1×10⁻¹ to 1×10⁻⁵ Pa, so that silicon (Si) atoms sublimate and remaining carbon (C) elements self-assemble, and graphene is laminated on the silicon carbide substrate.

### BRIEF DESCRIPTION OF DRAWINGS

FIG. 1 is a cross-sectional view of graphene on a semiconductor substrate formed by a method of manufacturing according to a first embodiment.

FIG. 2 is a cross-sectional view showing a step of manufacturing steps of graphene according to the first embodiment.

FIG. 3A is a cross-sectional view showing a step following FIG. 2.

FIG. 3B is a top view of FIG. 3A.

FIG. 4 is a cross-sectional view showing a step following FIG. 3A.

FIG. 5 is a cross-sectional view showing a step of the manufacturing steps of graphene according to a second embodiment.

FIG. 6A is a cross-sectional view showing a step following FIG. 5.

FIG. 6B is a top view of FIG. 6A.

FIG. 7 is a cross-sectional view showing a step following FIG. 6A.

FIG. 8 is a cross-sectional view showing a step of the manufacturing steps according to a modified example of the second embodiment.

### DESCRIPTION OF EMBODIMENTS

Next, the embodiments will be described with reference to the drawings. In the description of the drawings described below, the same or similar parts are assigned the same or similar reference numerals. However, it should be noted that the drawings are schematic, and the relationship between the thickness of each component and the plane dimensions is different from the actual one. Therefore, the specific thickness and dimensions should be determined by considering the following explanation. In addition, it should be noted that the drawings include portions in which the relationship and ratio of the dimensions of each other are different.

Further, the following embodiments illustrate devices and methods for realizing technical ideas, and do not specify materials, shapes, structures, arrangements, and the like of components. Various modifications may be made to the embodiments within the scope of claims.

### First Embodiment

A method of manufacturing graphene according to a first embodiment will be described with reference to the drawings.

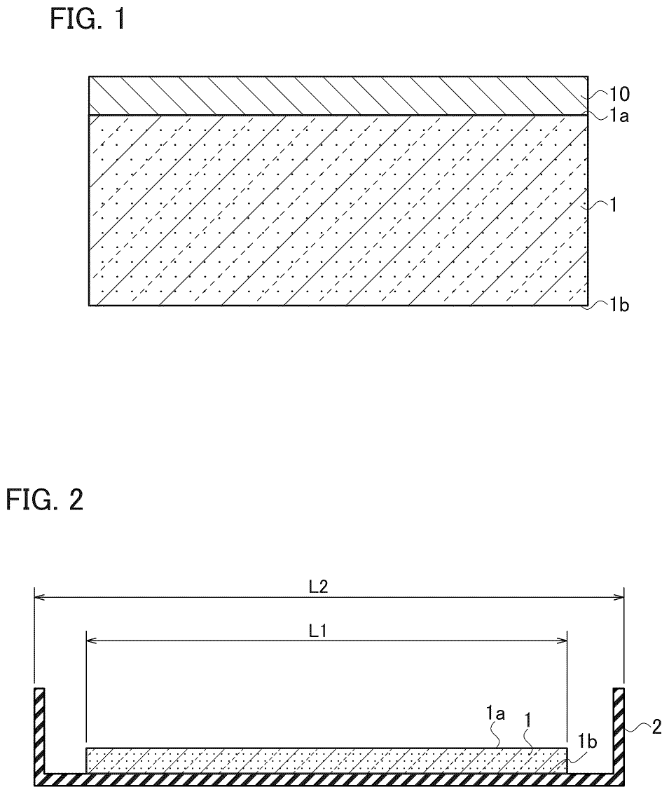

FIG. 1 is a cross-sectional view of a graphene layer 10 on a semiconductor substrate 1 formed by a method of manufacturing according to the first embodiment.

As shown in FIG. 1, the semiconductor substrate 1 has a first main surface 1a and a second main surface 1b opposite to the first main surface 1a. For example, single-crystal silicon carbide (SiC) can be used as the semiconductor substrate 1. In the following description, the semiconductor substrate 1 is also referred to as the SiC substrate 1. The SiC substrate 1 may be either a silicon termination surface or a carbon termination surface on the first main surface 1a. The thickness of the SiC substrate 1 may be, for example, 350 μm, but not limited thereto.

The graphene layer 10 has a single-layer structure of one layer or a laminated structure formed by more layers. The graphene layer 10 is arranged on the SiC substrate 1. The “more layers” here refers to two or more graphene layers 10.

Next, an example of a method of manufacturing graphene according to the first embodiment will be described.

FIGS. 2 to 4 are a cross-sectional view showing a step of manufacturing steps of graphene according to the first embodiment.

First, a natural oxide film is removed from the SiC substrate 1 using hydrofluoric acid (not shown) at the first main surface 1a of the SiC substrate 1.

Next, as shown in FIG. 2, the SiC substrate 1 is placed on a carbon susceptor 2. Specifically, a diameter L2 of the carbon susceptor 2 is longer than a diameter L1 of the SiC substrate 1. The thickness of the carbon susceptor 2 is, for example, about 500 μm. The carbon susceptor 2 is a generic term for a substrate holding body of a semiconductor substrate that is heated using, for example, an infrared lamp annealing apparatus (Rapid thermal annealing: RTA).

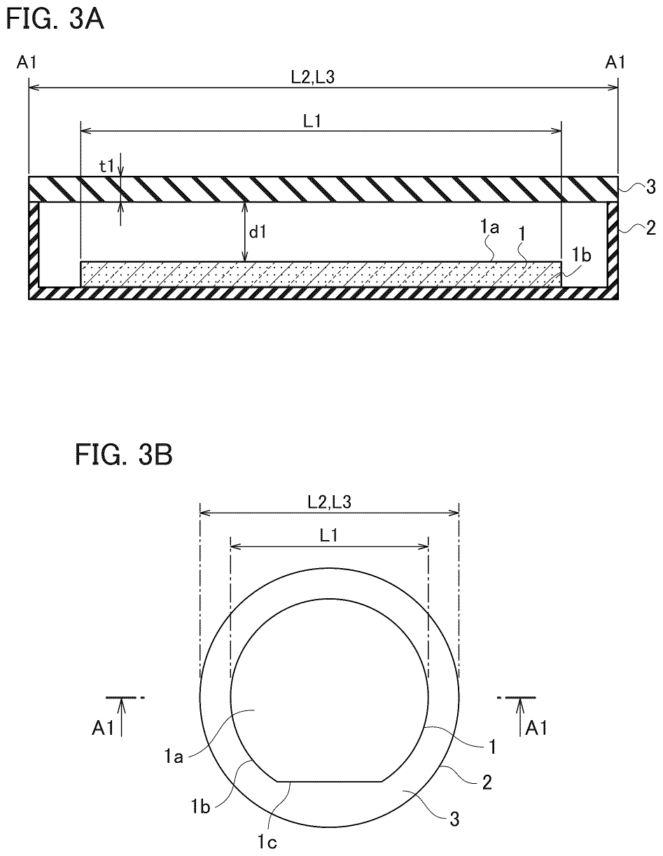

Next, as shown in FIG. 3A, a supply member 3 is placed above the carbon susceptor 2. Specifically, the supply member 3 is arranged at a distance from the SiC substrate 1. The supply member 3 includes silicon (Si) atoms and nitrogen (N) atoms. Specifically, a silicon nitride (Si₃N₄) substrate is adaptable to the supply member 3, for example. The silicon nitride substrate is formed by, for example, powder sintering. When the supply member 3 is heated, silicon atoms and nitrogen atoms sublimate. The silicon atoms and nitrogen atoms are supplied from the supply member 3, so that the sublimation of the silicon atoms from the SiC substrate 1 can be suppressed. In the following description, the supply member 3 is also referred to as a Si₃N₄ substrate 3.

As shown in FIG. 3A, a diameter L3 of the Si₃N₄ substrate 3 is longer than the diameter L1 of the SiC substrate 1. That is, as shown in FIG. 3B, the area of the carbon susceptor 2 or the supply member 3 is larger than the area of the SiC substrate 1 in a plan view of the first main surface 1a of the SiC substrate 1. A thickness t1 of the Si₃N₄ substrate 3 is, for example, about 0.5 to 5 mm. A distance d1 between the SiC substrate 1 and the Si₃N₄ substrate 3 may be, for example, about 1 to 5 cm. Here, the distance d1 between the SiC substrate 1 and the Si₃N₄ substrate 3 is provided such that the silicon atoms and nitrogen atoms contained in the Si₃N₄ substrate 3 sublimate by heating, and an atmosphere on the first main surface 1a of the SiC substrate 1 can be adjusted to an atmosphere containing the silicon atoms and nitrogen atoms. As shown in FIG. 3B, the SiC substrate 1 has an orientation flat 1c.

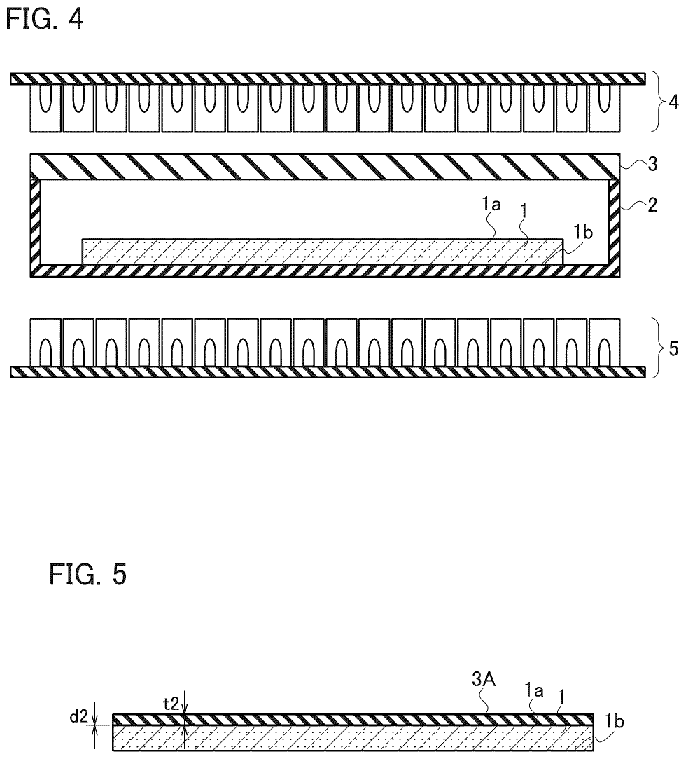

Next, as shown in FIG. 4, introduction into a chamber including a first heating source 4 and a second heating source 5 and heating are performed. Specifically, the supply member 3 and the carbon susceptor 2 are heated by at least one of the first heating source 4 and the second heating source 5. The first heating source 4 and the second heating source 5 are arranged at a distance. The carbon susceptor 2, the SiC substrate 1, and the supply member 3 are arranged between the first heating source 4 and the second heating source 5. An infrared lamp can be applied to the first heating source 4 and the second heating source 5. That is, for example, an infrared lamp annealing apparatus is adaptable to the chamber including the first heating source 4 and the second heating source 5. The infrared lamp annealing apparatus may be heated after exhausting atmospheric components in the chamber after introduction. The pressure after exhausting atmospheric components in the chamber may be about 1×10⁻⁶ to 1×10⁶ Pa. After exhausting atmospheric components in the chamber, argon (Ar) gas may be supplied and heated.

The SiC substrate 1 is heated by heating the carbon susceptor 2A. Specifically, the heating temperature of approximately 1,000° C. to 2,300° C. can be applied to the first heating source 4 and the second heating source 5. The lamp outputs of the first heating source 4 and the second heating source 5 need not be equal and may be different. Here, the lamp outputs of the first heating source 4 and the second heating source 5 are, for example, the infrared lamp outputs of the infrared lamp annealing apparatus. The heating conditions of the carbon susceptor 2 and the Si₃N₄ substrate 3 may be, for example, about 1,600° C. for 10 minutes. Here, the heating conditions of the carbon susceptor 2 and the Si₃N₄ substrate 3 refer to a temperature at which the silicon atoms of the SiC substrate 1 sublimate and the silicon atoms and nitrogen atoms of the Si₃N₄ substrate sublimate.

When heating by the first heating source 4 and the second heating source 5, the carbon susceptor 2 and the Si₃N₄ substrate 3 are heated simultaneously as shown in FIG. 4. Upon heating, silicon atoms and nitrogen atoms in the Si₃N₄ substrate 3 sublimate and are supplied to the first main surface 1a of the SiC substrate 1. Therefore, the sublimation of silicon atoms from the SiC substrate 1 is suppressed, and the growth rate of the graphene layer 10 is suppressed. By suppressing a growth rate of the graphene layer 10, the occurrence of step bunching can be suppressed.

One or more graphene layers 10 are formed on the SiC substrate 1 by heating the SiC substrate 1. Specifically, Si sublimates from the first main surface 1a of the SiC substrate 1, and the one or more graphene layers 10 are formed on the SiC substrate 1. The nitrogen atoms sublimated by the Si₃N₄ substrate 3 may be added to the SiC substrate 1 or the one or more graphene layers 10 formed on the SiC substrate 1.

The one or more graphene layers 10 according to the first embodiment is completed by the above steps.

According to the first embodiment, the silicon atoms and nitrogen atoms are supplied from the Si₃N₄ substrate 3 by the first heating source 4 and the second heating source 5, so that the sublimation of the silicon atoms in the SiC substrate 1 is suppressed, and the one or more graphene layers 10 with uniform laminate formation can be formed on the SiC substrate 1.

### Second Embodiment

A method of manufacturing graphene according to a second embodiment will be described with reference to the drawings.

FIGS. 5 to 7 are a cross-sectional view showing a step of manufacturing steps of graphene according to the second embodiment.

In the manufacturing steps of graphene according to the second embodiment, a nitride film (Si₃N₄) 3A is provided instead of the Si₃N₄ substrate 3, which is an example of a supply member in the manufacturing steps of graphene according to the first embodiment. The nitride film 3A is another example of the supply member. Here, the nitride film 3A is a film including the silicon atoms and nitrogen atoms, and is also called, for example, a silicon nitride film, silicon nitride, or SiN. In the following description, the nitride film 3A, which is another example of the supply member, will be described. Hereinafter, the same steps as those of the first embodiment will not be described.

First, as shown in FIG. 5, the nitride film 3A is formed on the SiC substrate 1. Specifically, the method of forming the nitride film 3A includes, for example, a plasma chemical vapor deposition method (plasma CVD), a thermochemical vapor deposition method (thermal CVD), and an atomic layer deposition method (ALD). As the method of forming the nitride film 3A, the ALD method is preferable in that a uniform film can be formed regularly along the first main surface 1a on the SiC substrate 1.

A thickness t2 of the nitride film 3A may be, for example, about 1 to 5 nm. That is, the thickness t2 of the nitride film 3A may be provided such that the silicon atoms and nitrogen atoms sublimate by heating, thereby removing the nitride film 3A. In the manufacturing steps of graphene according to the first embodiment, the SiC substrate 1 and the Si₃N₄ substrate 3 are arranged at the distance d1, while in the manufacturing steps of graphene according to the second embodiment, the SiC substrate 1 and the nitride film 3A are arranged in contact with each other. That is, a distance d2 between the SiC substrate 1 and the nitride film 3A is 0, and the SiC substrate 1 and the nitride film 3A may be in direct contact with each other.

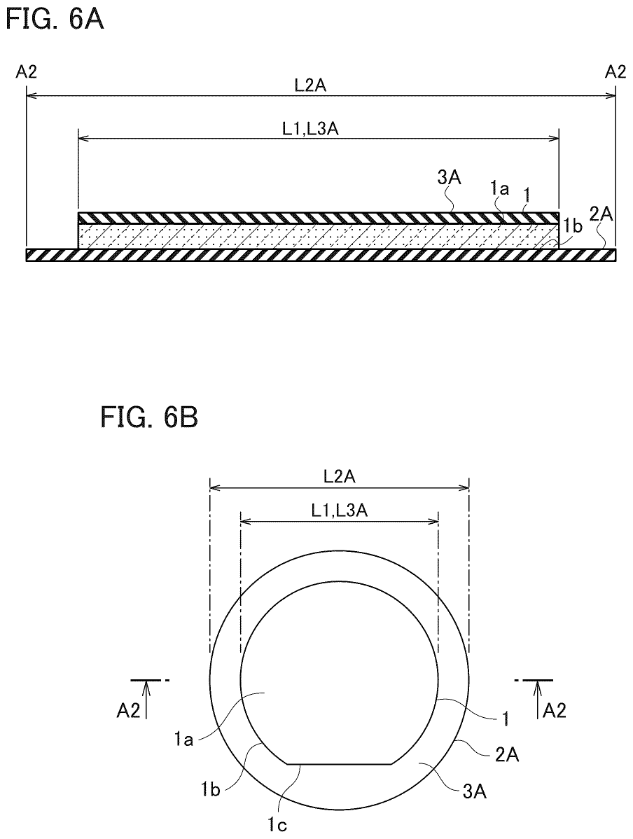

Next, as shown in FIG. 6A, the SiC substrate 1 is placed on the carbon susceptor 2A, which is an example of a carbon susceptor. Specifically, a diameter L2A of the carbon susceptor 2A is longer than the diameter L1 of the SiC substrate 1. A diameter L3A of the nitride film 3A is equal to the diameter L1 of the SiC substrate 1. That is, as shown in FIG. 6B, the area of the carbon susceptor 2A is larger than the area of the SiC substrate 1 in a plan view of the first main surface 1a of the SiC substrate 1. The area of the nitride film 3A is equal to the area of the SiC substrate 1. Although not shown, the area of the carbon susceptor 2A may be equal to the area of the SiC substrate 1 in the plan view of the first main surface 1a of the SiC substrate 1. As shown in FIG. 6B, the SiC substrate 1 has the orientation flat 1c.

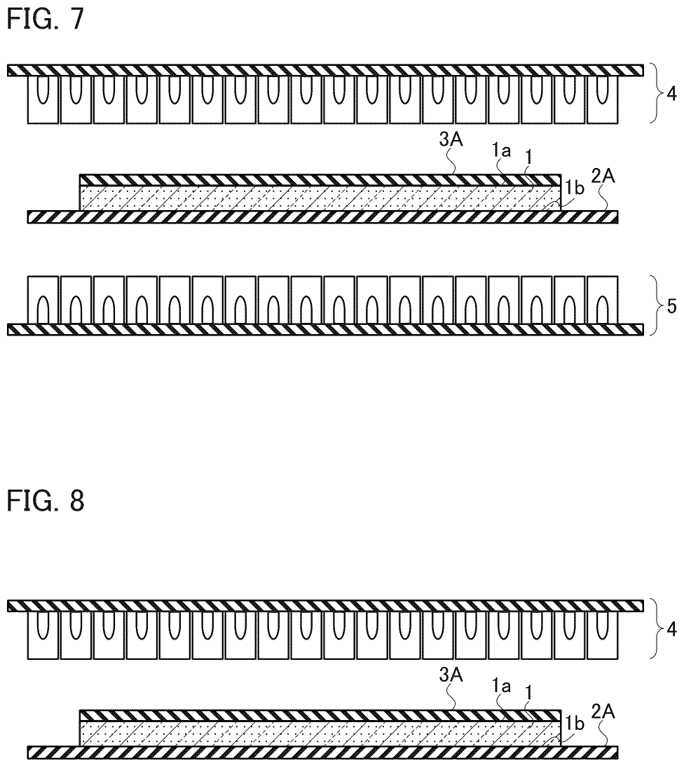

Next, as shown in FIG. 7, introduction into the chamber including the first heating source 4 and the second heating source 5 and heating are performed. Specifically, the first heating source 4 and the second heating source 5 are arranged at a distance. The carbon susceptor 2, the SiC substrate 1, and the supply member 3 are arranged between the first heating source 4 and the second heating source 5. An infrared lamp can be applied to the first heating source 4 and the second heating source 5. That is, for example, an infrared lamp annealing apparatus can be applied to the chamber including the first heating source 4 and the second heating source 5. The infrared lamp annealing apparatus may be heated after exhausting atmospheric components in the chamber after introduction. The pressure after exhausting atmospheric components in the chamber may be about 1×10⁻⁶ to 1×10⁶ Pa. After exhausting atmospheric components in the chamber, argon (Ar) gas may be supplied and heated.

The SiC substrate 1 is heated by heating the carbon susceptor 2A. Specifically, the heating temperature of approximately 1,000° C. to 2,300° C. can be applied to the first heating source 4 and the second heating source 5. The lamp outputs of the first heating source 4 and the second heating source 5 need not be equal and may be different. Here, the lamp outputs of the first heating source 4 and the second heating source 5 are, for example, the infrared lamp outputs of the infrared lamp annealing apparatus. The heating conditions of the carbon susceptor 2A and the nitride film 3A may be, for example, about 1,600° C. for 10 minutes. Here, the heating conditions of the carbon susceptor 2A and the nitride film 3A refer to a temperature at which the silicon atoms of the SiC substrate 1 sublimate, the silicon atoms and the nitrogen atoms of the nitride film 3A sublimate, and all the nitride films 3A sublimate.

When heating by the first heating source 4 and the second heating source 5, the carbon susceptor 2A and the nitride film 3A are heated simultaneously as shown in FIG. 7. Upon heating, silicon atoms and nitrogen atoms in the nitride film 3A sublimate and supplied to the first main surface 1a of the SiC substrate 1. Therefore, the sublimation of silicon atoms from the SiC substrate 1 is suppressed, and the growth rate of the graphene layer 10 is suppressed. By suppressing the growth rate of the graphene layer 10, the occurrence of step bunching can be suppressed.

The one or more graphene layers 10 are formed on the SiC substrate 1 by heating the SiC substrate 1. Specifically, Si sublimates from the first main surface 1a of the SiC substrate 1, and the one or more graphene layers 10 are formed on the SiC substrate 1. The nitrogen atoms sublimated by the nitride film 3A may be added to the SiC substrate 1 or the one or more graphene layers 10 formed on the SiC substrate 1.

The one or more graphene layer 10 according to the second embodiment is completed by the above steps.

According to the second embodiment, the silicon atoms and nitrogen atoms are supplied from the nitride film 3A by the first heating source 4 and the second heating source 5, so that the sublimation of the silicon atoms in the SiC substrate 1 is suppressed, and the one or more graphene layers 10 with uniform laminate formation can be formed on the SiC substrate 1.

### Modified Example of Second Embodiment

A method of manufacturing graphene according to a modified example of the second embodiment will be described with reference to the drawings.

FIG. 8 is a cross-sectional view showing a step of the manufacturing steps of graphene according to the modified example of the second embodiment.

As shown in FIG. 8, in the manufacturing steps of graphene according to the modified example of the second embodiment, heating is performed by the first heating source 4 instead of heating by the first heating source 4 and the second heating source 5 in the manufacturing steps of graphene according to the second embodiment. That is, the carbon susceptor 2A and the nitride film 3A are heated simultaneously by the first heating source 4. Hereafter, other manufacturing methods and other operations of the second embodiment are the same, and the description thereof will be omitted.

### OTHER EMBODIMENTS

As noted above, one embodiment has been described, but the descriptions and drawings that form part of the disclosure are illustrative and should not be construed as limiting. The disclosure will reveal to those skilled in the art a variety of alternative embodiments, examples, and operational techniques. As such, this embodiment includes a variety of embodiments, and the like, not described herein.

### Examples of Embodiments

Examples of the embodiments are described below. The embodiments are not limited to the following examples.

### Supplementary Note 1

A method of manufacturing graphene, including:
placing a semiconductor substrate on a carbon susceptor;
   placing a supply member above the carbon susceptor or the semiconductor substrate;
   heating the supply member and the carbon susceptor by at least one of a first heating source and a second heating source;
   heating the semiconductor substrate by heating the carbon susceptor; and
   forming one or more graphene layers on the semiconductor substrate.

### Supplementary Note 2

The method of manufacturing graphene according to [Supplementary Note 1], including:
providing the supply member with silicon atoms and nitrogen atoms;
heating the supply member to sublimate the silicon atoms and nitrogen atoms;
adjusting an atmosphere on the semiconductor substrate to an atmosphere containing the silicon atoms and nitrogen atoms.

### Supplementary Note 3

The method of manufacturing graphene according to [Supplementary Note 1] or [Supplementary Note 2], in which the supply member is arranged at a distance from the semiconductor substrate.

### Supplementary Note 4

The method of manufacturing graphene according to [Supplementary Note 3], in which a distance between the semiconductor substrate and the supply member is 1 to 5 cm.

### Supplementary Note 5

The method of manufacturing graphene according to [Supplementary Note 3], in which a thickness of the supply member is 0.5 to 5 mm.

### Supplementary Note 6

The method of manufacturing graphene according to [Supplementary Note 3], in which the supply member is a silicon nitride substrate.

### Supplementary Note 7

The method of manufacturing graphene according to [Supplementary Note 1] or [Supplementary Note 2], in which the supply member is arranged in contact with the semiconductor substrate.

### Supplementary Note 8

The method of manufacturing graphene according to [Supplementary Note 7], in which the thickness of the supply member is 1 to 5 nm.

### Supplementary Note 9

The method of manufacturing graphene according to [Supplementary Note 7], in which the supply member is a nitride film.

### Supplementary Note 10

The method of manufacturing graphene according to any one of [Supplementary Note 1] to [Supplementary Note 9], in which the area of the carbon susceptor or the supply member is larger than the area of the semiconductor substrate in a plan view of the first main surface of the semiconductor substrate.

### Supplementary Note 11

The method of manufacturing graphene according to any one of [Supplementary Note 1] to [Supplementary Note 9], in which the area of the carbon susceptor or the supply member is equal to the area of the semiconductor substrate in a plan view of the first main surface of the semiconductor substrate.

### Supplementary Note 12

The method of manufacturing graphene according to any one of [Supplementary Note 1] to [Supplementary Note 11], in which the semiconductor substrate is formed of single-crystal silicon carbide.

### Supplementary Note 13

The method of manufacturing graphene according to any one of [Supplementary Note 1] to [Supplementary Note 12], in which the nitrogen atoms sublimated by the supply member are added to the semiconductor substrate or the one or more graphene layers formed on the semiconductor substrate.

### Supplementary Note 14

The method of manufacturing graphene according to any one of [Supplementary Note 1] to [Supplementary Note 13], in which lamp outputs of the first heating source and the second heating source are equal.

### Supplementary Note 15

The method of manufacturing graphene according to any one of [Supplementary Note 1] to [Supplementary Note 13], in which lamp outputs of the first heating source and the second heating source are different.

### Supplementary Note 16

The method of manufacturing graphene according to any one of [Supplementary Note 1] to [Supplementary Note 15], in which the carbon susceptor, the semiconductor substrate, and the supply member are arranged between the first heating source and the second heating source.

According to [Supplementary Note 1] to [Supplementary Note 16], the silicon atoms and nitrogen atoms are supplied from the semiconductor substrate, so that the sublimation of silicon atoms in the semiconductor substrate is suppressed, and the graphene layer with uniform laminate formation can be formed on the semiconductor substrate.

1. A method of manufacturing graphene, comprising:
placing a semiconductor substrate on a carbon susceptor;
placing a supply member above the carbon susceptor or the semiconductor substrate;
heating the supply member and the carbon susceptor by at least one of a first heating source and a second heating source;
heating the semiconductor substrate by heating the carbon susceptor; and
forming one or more graphene layers on the semiconductor substrate.

2. The method of manufacturing graphene according to claim 1, comprising:
providing the supply member with silicon atoms and nitrogen atoms;
heating the supply member to sublimate the silicon atoms and nitrogen atoms;
adjusting an atmosphere on the semiconductor substrate to an atmosphere containing the silicon atoms and nitrogen atoms.

3. The method of manufacturing graphene according to claim 1, wherein the supply member is arranged at a distance from the semiconductor substrate.

4. The method of manufacturing graphene according to claim 3, wherein a distance between the semiconductor substrate and the supply member is 1 to 5 cm.

5. The method of manufacturing graphene according to claim 3, wherein a thickness of the supply member is 0.5 to 5 mm.

6. The method of manufacturing graphene according to claim 3, wherein the supply member is a silicon nitride substrate.

7. The method of manufacturing graphene according to claim 1, wherein the supply member is arranged in contact with the semiconductor substrate.

8. The method of manufacturing graphene according to claim 7, wherein the thickness of the supply member is 1 to 5 nm.

9. The method of manufacturing graphene according to claim 7, wherein the supply member is a nitride film.

10. The method of manufacturing graphene according to claim 1, wherein the area of the carbon susceptor or the supply member is larger than the area of the semiconductor substrate in a plan view of the first main surface of the semiconductor substrate.

11. The method of manufacturing graphene according to claim 1, wherein the area of the carbon susceptor or the supply member is equal to the area of the semiconductor substrate in a plan view of the first main surface of the semiconductor substrate.

12. The method of manufacturing graphene according to claim 1, wherein the semiconductor substrate is formed of single-crystal silicon carbide.

13. The method of manufacturing graphene according to claim 1, wherein the nitrogen atoms sublimated by the supply member are added to the semiconductor substrate or the one or more graphene layers formed on the semiconductor substrate.

14. The method of manufacturing graphene according to claim 1, wherein lamp outputs of the first heating source and the second heating source are equal.

15. The method of manufacturing graphene according to claim 1, wherein lamp outputs of the first heating source and the second heating source are different.

16. The method of manufacturing graphene according to claim 1, wherein the carbon susceptor, the semiconductor substrate, and the supply member are arranged between the first heating source and the second heating source.
